(19) United States
(12) Patent Application Publication
(10) Pub. No.: US 2014/0092123 A1
(43) Pub. Date: Apr. 3, 2014

(54) DRAWING CONTROL DEVICE

(71) Applicants: Masaki Hamada, Tokyo (JP); Yoshiyuki Kato, Tokyo (JP); Akira Torii, Tokyo (JP)

(72) Inventors: Masaki Hamada, Tokyo (JP); Yoshiyuki Kato, Tokyo (JP); Akira Torii, Tokyo (JP)

(73) Assignee: Mitsubishi Electric Corporation, Tokyo (JP)

(21) Appl. No.: 14/123,641

(22) PCT Filed: Aug. 15, 2011
(86) PCT No.: PCT/JP2011/004584

§ 371 Date: Dec. 3, 2013

(51) Int. Cl. G06T 11/20

(52) U.S. Cl. CPC G06T 11/20
USPC 345/619

(57) ABSTRACT

When receiving register setting information about a graphic on which a drawing process is carried out, a drawing control unit 10 determines whether or not a dedicated drawing unit 30 or a common drawing unit 40 is in a busy state, and, when the dedicated drawing unit or the common drawing unit is in the busy state, compares data in a register 31a or 32a or a register 40a with the register setting information. When the result of the comparison shows that an update is needed, the register setting information is stored in a command buffer 12. When the busy state is released, the register 31a or 32a or the register 40a is updated on the basis of the register setting information stored in the command buffer 12.

### FIELD OF THE INVENTION

The present invention relates to a drawing control device equipped with a drawing unit for carrying out graphic drawing, and a drawing controlling unit for controlling a register setting on the drawing unit.

### BACKGROUND OF THE INVENTION

Conventionally, for an information processing device which sets, as a parameter, motion control information from a CPU, and starts an operation on the basis of the set information, an attempt has been made to shorten the waiting time at the time that the information processing device makes the parameter setting, thereby improving the processing performance of the whole system. For example, an information processing device disclosed by patent reference 1 is characterized in that the information processing device uses a technique of making a comparison between a parameter transferred and a parameter of the same type previously written therein and being held to determine whether or not the parameter is updated, and transferring only the parameter when updated.

### RELATED ART DOCUMENT

### Patent Reference

Patent reference 1: Japanese Unexamined Patent Application Publication No. JP 63-298631 A

### SUMMARY OF THE INVENTION

### Problems to be Solved by the Invention

Because the conventional information processing device is constructed as above, there is provided an advantage of being able to eliminate conversion and transfer of a parameter which is not updated. A problem is, however, that when the number of parameters increases, the decode circuit becomes complicated and a register setting when a main processing unit is working is not taken into consideration, for example.

The present invention is made in order to solve the above-mentioned problem, and it is therefore an object of the present invention to provide a drawing control device that can shorten a drawing busy time and a waiting time for parameter setting and improve drawing performance thereof regardless of the number of parameters and the order in which a CPU sets the parameters thereto.

### Means for Solving the Problem

In accordance with the present invention, there is provided a drawing control device including: a drawing unit that has a register for drawing and carries out a drawing process of drawing a graphic on the basis of data in the register for drawing; and a drawing controller that determines whether or not the drawing unit is in a busy state when receiving register setting information about the graphic on which the drawing process is carried out, that compares the data in the register for drawing with the register setting information when the drawing unit is in the busy state and stores the register setting information in a command buffer only when an update is needed, and that updates the register for drawing on the basis of the register setting information stored in the command buffer when the busy state is released and an update is needed.

### Advantages of the Invention

The drawing control device in accordance with the present invention compares the data in the register for drawing with the register setting information when the drawing unit is in the busy state and stores the register setting information in the command buffer only when an update is needed. As a result, the drawing busy time and the waiting time for parameter setting can be shortened and hence the drawing performance can be improved.

### BRIEF DESCRIPTION OF THE FIGURES

FIG. 1 is a block diagram of a drawing control device in accordance with Embodiment 1 of the present invention;

FIG. 2 is a flow chart showing the operation of the drawing control device in accordance with Embodiment 1 of the present invention;

FIG. 3 is an explanatory drawing showing the format of a register setting command of the drawing control device in accordance with Embodiment 1 of the present invention;

FIG. 4 is a block diagram of a drawing control device in accordance with Embodiment 2 of the present invention; and

FIG. 5 is a flow chart showing the operation of the drawing control device in accordance with Embodiment 2 of the present invention.

### EMBODIMENTS OF THE INVENTION

Hereafter, in order to explain this invention in greater detail, the preferred embodiments of the present invention will be described with reference to the accompanying drawings.

### Embodiment 1

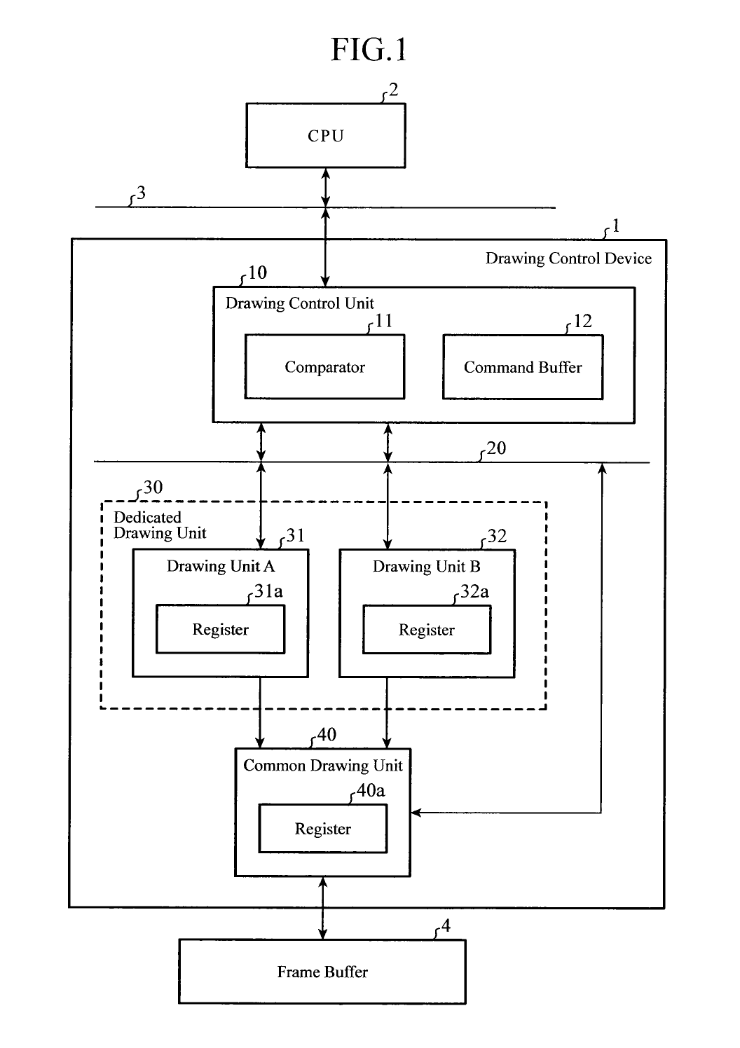

FIG. 1 is a block diagram showing a drawing control device in accordance with this embodiment. The drawing control device 1 shown in this figure includes a drawing control unit (drawing controller) 10, a register bus 20, a dedicated drawing unit (drawing unit) 30, and a common drawing unit (drawing unit) 40.

The drawing control unit 10 receives register setting information including the coordinates and the drawing colors of a graphic to be drawn, via a CPU bus 3, from a CPU 2. Because an address, a read/write control signal, byte control, write data, etc. are typically inputted thereto, via the CPU bus 3, from the CPU 2, the drawing control unit decodes the inputted address, and accesses the corresponding dedicated drawing unit 30 via the register bus 20. The drawing control unit 10 also has a comparator 11 for making a comparison between either the value of a register 31a or 32a read from the dedicated drawing unit 30 via the register bus 20 or the value of a register 40a read from the common drawing unit 40 via the register bus 20, and data to which the value is to be updated, and a command buffer 12 for, when the comparison result shows that there is a mismatch between them, storing the register setting information.

The dedicated drawing unit 30 has a structure of being divided into portions respectively associated with drawing functions (for example, the dedicated drawing unit is divided into a drawing unit (A) 31 used for rectangle drawing and a drawing unit (B) 32 used for circle drawing), and the drawing units include the registers 31a and 32a and have actual units serving as registers for drawing respectively. Referring to FIG. 1, although the dedicated drawing unit 30 is divided into the two drawing units (A) 31 and (B) 32, the dedicated drawing unit can be alternatively divided into a larger number of portions. The dedicated drawing unit 30 generates and outputs data about pixels included in the graphic on the basis of the register setting information from the drawing control unit 10.

The common drawing unit 40 includes the register 40a, and has an actual unit serving as a register for drawing which is shared by the drawing units (A) 31 and (B) 32 when these drawing units are working. The common drawing unit mediates between inputs of pixel data from each dedicated drawing unit, and carries out a pixel computation, such as an a blend, and writes image element data in a frame buffer 4. Although the frame buffer 4 is disposed outside the drawing control device 1 in the example shown in FIG. 1, the frame buffer can be alternatively disposed in the drawing control device 1.

In the example shown in FIG. 1, it is assumed that each of the drawing control unit 10, the register bus 20, the dedicated drawing unit 30, and the common drawing unit 40, which are the components of the drawing control device 1, is constructed of hardware for exclusive use (e.g., a semiconductor integrated circuit substrate on which an MPU (Micro Processing Unit) is mounted). As an alternative, in a case in which the drawing control device 1 consists of a computer (including a mobile phone, a mobile information terminal, a car navigation device, or the like that can execute a drawing program, which will be mentioned below, as well as a personal computer), a drawing program in which processes carried out by the drawing control unit 10, the register bus 20, the dedicated drawing unit 30, and the common drawing unit 40 are described can be stored in a memory of the computer and a CPU (Central Processing Unit) of the computer can be made to execute the drawing program stored in the memory.

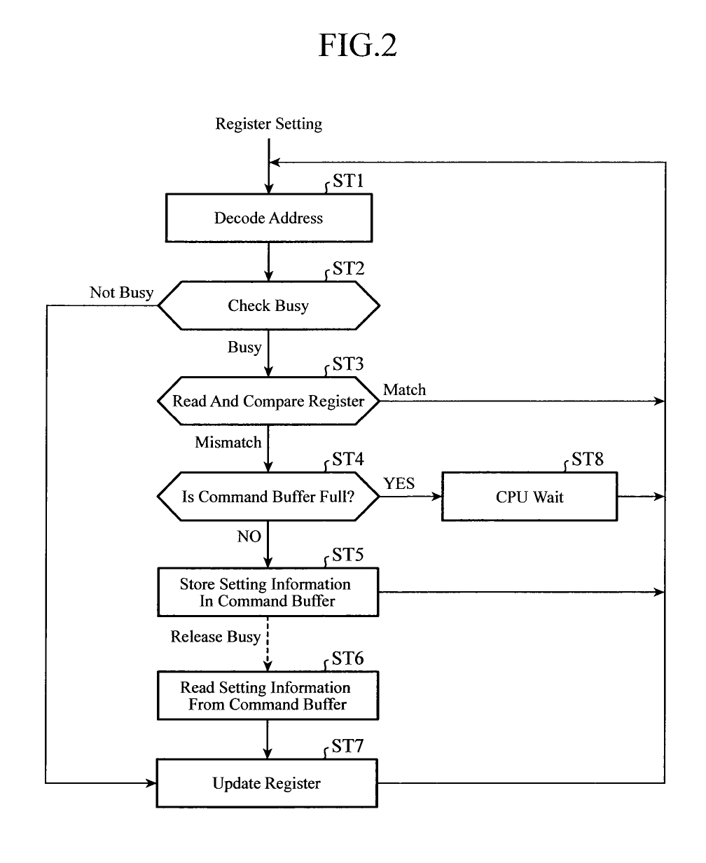

Next, the operation of the drawing control device in accordance with Embodiment 1 will be explained. FIG. 2 is a flow chart showing processes carried out by the drawing control device 1 in accordance with Embodiment 1 of the present invention. The drawing control device 1 starts its operation in response to a drawing processing start command from the CPU 2 of the system equipped with the drawing control device 1. The drawing control unit 10 decodes an address inputted thereto from the CPU bus 3, and determines which block in the drawing control device 1 will be accessed (step ST1). At this time, by promptly sending a reply back to the CPU bus 3 regardless of the presence or absence of a register update which will be shown below, the drawing control unit performs a control operation of causing the CPU 2 not to wait wastefully.

The drawing control unit then checks whether or not the dedicated drawing unit 30 is in a busy state and whether or not the common drawing unit 40 is in a busy state (step ST2). A case in which the dedicated drawing unit 30 is in the busy state is a state in which the dedicated drawing unit is generating data about pixels included in a graphic, and a case in which the common drawing unit 40 is in the busy state is a state in which the common drawing unit is outputting pixel data to the frame buffer 4. When the result of the checking in step ST2 shows that a criterion by which to judge whether a register update can be performed is satisfied (not busy), the drawing control unit performs a register update as usual (step ST7).

For example, the criterion by which to judge whether a register update can be performed can be satisfied in a case in which a target block and blocks connected on an upstream side of the target block are not in the busy state. In the case of the structure shown in FIG. 1, for example, when the common drawing unit 40 is defined as the target block, the drawing unit (A) 31 and the drawing unit 32 (B) correspond to blocks connected on an upstream side of the target block. The drawing control device 1 can also deal with a case in which the update criterion needs to be controlled more finely. For example, the drawing control device can deal with a case in which a drawing unit C is further disposed on a downstream side of the drawing unit (A) 31, and whether or not either the drawing unit (A) 31 or the drawing unit (B) 32 is in the busy state and whether or not the drawing unit C is in the busy state are checked, and a case in which a special criterion is set up only as a criterion by which to judge whether an update can be performed on a certain register.

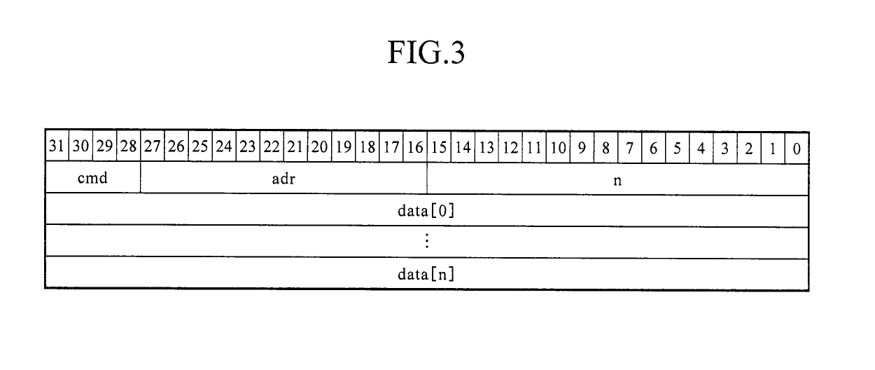

In contrast, when, in step ST2, the criterion by which to judge whether a register update can be performed is not satisfied (busy), the drawing control device reads the register value of the block which is the target for register update via the register bus 20, and compares the register value with the data to which the register value is to be updated (step ST3). Because the update of the register can be omitted when the comparison result shows that they match each other, the drawing control device shifts to a state in which the drawing control device waits for reception of a register setting made thereon from the CPU 2. In contrast, when the comparison result shows that they do not match each other, the drawing control device determines whether or not the command buffer 12 in the drawing control unit 10 is full (step ST4). When the result of the determination shows that the command buffer is not full, the drawing control device stores the register setting information in the command buffer 12 (step ST5). FIG. 3 is an example of the format of the register setting command which is stored in the command buffer 12, and data are handled in units of 32 bits in this format. When a register address (adr), write data (data[0] . . . data[n]), and the number of write data (n: the number of data-1) and the number of data is two or more (n>0)), the register address at which data is written is incremented. Further, cmd shows the register setting command. Only when the command buffer 12 becomes full, the drawing control device causes the CPU bus 3 to wait (step ST8).

When the criterion by which to judge whether a register update can be performed is then satisfied (the busy state is released), the drawing control unit 10 reads the register setting information stored in the command buffer 12 (step ST6), and carries out a register update on the target drawing block (step ST7). The process shown by a dotted line in FIG. 2 is carried out independently of the flow of the register setting.

In order to bring the ability of the drawing control device 1 into full play, the drawing control device needs to perform the series of processes including the busy checking, the register data reading, and the comparison in cycles shorter than the time intervals at which the CPU bus 3 is accessed. Further, in the case of the structure shown in FIG. 1, the drawing units (A) 31 and (B) 32 can also be made to operate in parallel with each other within the bounds of not changing the order in which the drawing units (A) 31 and (B) 32 perform their respective drawing operations.

As can be seen from the above description, because the drawing control unit 1 in accordance with this Embodiment 1 carries out determination of a target block for register update by using the busy state of each block, and, after storing only register setting information about a register which needs to be updated in the command buffer 12, makes a setting on a register for drawing at an appropriate timing, the operation efficiency of the drawing control unit 10 can be improved. Further, because the drawing control unit extracts only an access to a register which needs to be updated and stores the access in the command buffer 12, the size of the command buffer 12 can be reduced as compared with a case of storing a series of commands in the command buffer 12 in advance.

As previously explained, because the drawing control device in accordance with Embodiment 1 includes a drawing unit that has a register for drawing and carries out a drawing process of drawing a graphic on the basis of data in the register for drawing, and a drawing controller that determines whether or not the drawing unit is in a busy state when receiving register setting information about the graphic on which the drawing process is carried out, that compares the data in the register for drawing with the register setting information when the drawing unit is in the busy state and stores the register setting information in a command buffer only when an update is needed, and that updates the register for drawing on the basis of the register setting information stored in the command buffer when the busy state is released and an update is needed, the drawing busy time and the waiting time for parameter setting can be shortened and hence the drawing performance can be improved.

Further, because in the drawing control device in accordance with Embodiment 1, the drawing controller can control the reading of the register setting information stored in the command buffer and the update of the register independently from an access from a CPU that sends out the register setting information, the drawing control device prevents the CPU from waiting wastefully.

Further, because in the drawing control device in accordance with Embodiment 1, the drawing controller includes a dedicated drawing unit that is divided into portions respectively associated with drawing functions, and a common drawing unit that mediates between inputs of pixel data thereto from the dedicated drawing unit, and that carries out a predetermined pixel computation and writes pixel data in a frame buffer, this embodiment can also be applied to the drawing control device equipped with the dedicated drawing unit and the common drawing unit.

Further, because the drawing control program in accordance with Embodiment 1 causes a computer to function as: a drawing unit that has a register for drawing and carries out a drawing process of drawing a graphic on the basis of data in the register for drawing; and a drawing controller that determines whether or not the drawing unit is in a busy state when receiving register setting information about the graphic on which the drawing process is carried out, that compares the data in the register for drawing with the register setting information when the drawing unit is in the busy state and stores the register setting information in a command buffer only when an update is needed, and that updates the register for drawing on the basis of the register setting information stored in the command buffer when the busy state is released and an update is needed, a drawing control device that can shorten the drawing busy time and the waiting time for parameter setting and hence can improve the drawing performance can be implemented on the computer.

### Embodiment 2

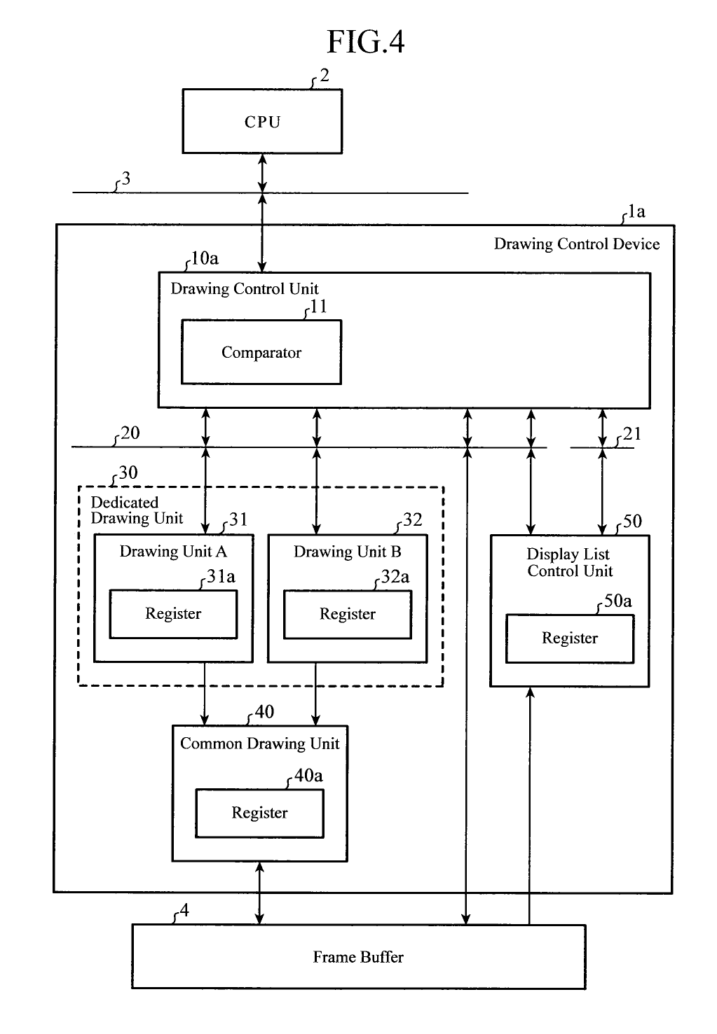

FIG. 4 is a block diagram showing a drawing control device la in accordance with Embodiment 2 of the present invention. While the register setting information is stored in the command buffer 12 in Embodiment 1, a command buffer 12 is removed from a drawing control unit 10a and a display list control unit 50 is added to the drawing control device in Embodiment 2. Register setting information is stored temporarily in a frame buffer 4 (external memory) in a display list form, and the display list control unit 50 reads the data from the frame buffer and uses this data. Further, a second register bus 21 is added between the drawing control unit 10a and the display list control unit 50.

The display list control unit 50 has a register 50a, and reads items of a display list from the frame buffer 4 in turn according to a start command from the drawing control unit 10a and decodes a command. It is desirable that the form of the display list consists of a register write command shown in FIG. 3, and a jump command, a subroutine command and so on corresponding to another address of the display list.

Although it is assumed that each component consists of hardware for exclusive use in Embodiment 2, in a case in which the drawing control device la consists of a computer, like in the case of Embodiment 1, a drawing program in which processes carried out by the drawing control unit 10a, a register bus 20, the second register bus 21, a dedicated drawing unit 30, a common drawing unit 40, and the display list control unit 50 are described can be stored in a memory of the computer, and a CPU can be made to execute the drawing program.

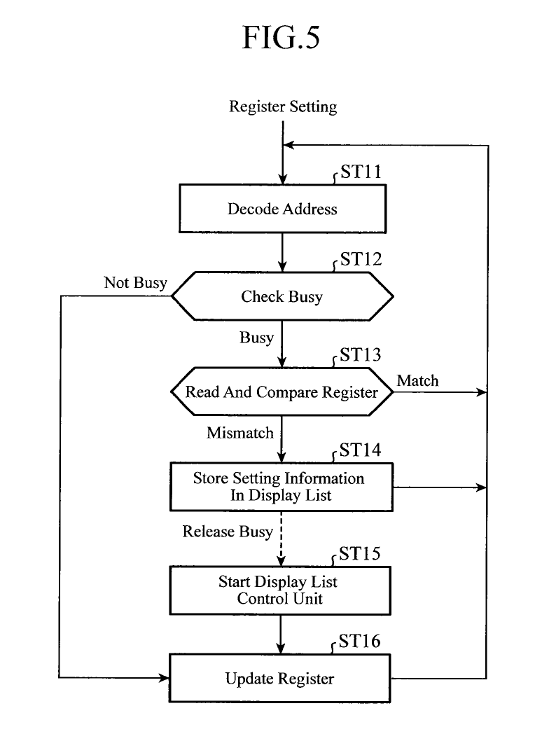

FIG. 5 is a flow chart showing processes carried out by the drawing control device la in accordance with Embodiment 2 of the present invention. The drawing control unit 10a decodes an address inputted thereto from a CPU bus 3, and determines which block in the drawing control device la will be accessed (step ST1). The drawing control unit then checks whether or not the dedicated drawing unit 30 is in a busy state and whether or not the common drawing unit 40 is in a busy state (step ST12). This busy checking is the same as that in step ST2 in Embodiment 1. When the result of the checking shows that a criterion by which to judge whether a register update can be performed is satisfied (not busy), the drawing control unit performs a register update as usual (step ST16).

In contrast, when, in step ST12, the criterion by which to judge whether a register update can be performed is not satisfied, the drawing control device reads the register value of a block which is a target for register update via the register bus 20, and compares the register value with data to which the register value is to be updated (step ST13). Because the update of the register can be omitted when the comparison result shows that they match each other, the drawing control device shifts to a state in which the drawing control device waits for reception of a register setting made thereon from a CPU 2. In contrast, when the comparison result shows that they do not match each other, the drawing control device stores the register setting information in the frame buffer 4 (external memory) (step ST14). After that, when the busy state is released, the drawing control unit 10a specifies the start address of the display list to start the display list control unit 50 (step ST15).

The display list control unit 50 reads the register setting information from the frame buffer 4, and outputs a register setting address, write data, etc. to the drawing control unit 10a via the second register bus 21. The drawing control unit 10a mediates between an access from the CPU 2 and an access from the display list control unit 50, and performs an update of the register of the target drawing block.

As can be seen from the above description, in accordance with Embodiment 2, the necessity to dispose a command buffer in the drawing control unit 10a is eliminated, and the circuit scale can be reduced. Further, because only an access to a register which needs to be updated is extracted, the display list size can be reduced as compared with a case of generating a display list in advance.

As previously explained, because the drawing control device in accordance with Embodiment 2 includes a drawing unit that has a register for drawing and carries out a drawing process of drawing a graphic on the basis of data in the register for drawing; and a drawing controller that determines whether or not the drawing unit is in a busy state when receiving register setting information about the graphic on which the drawing process is carried out, that compares the data in the register for drawing with the register setting information when the drawing unit is in the busy state and stores the register setting information in a display list form in a command buffer only when an update is needed, and that updates the register for drawing on the basis of the register setting information stored in the command buffer in the display list form when the busy state is released and an update is needed, the drawing busy time and the waiting time for parameter setting can be shortened and hence the drawing performance can be improved.

Further, because in the drawing control device in accordance with Embodiment 2, the register setting information in the display list form is stored in an external memory, and the drawing control device includes a display list controller that decodes the stored display list and transfers this display list decoded thereby to the drawing controller, the display list size can be reduced as compared with a case of generating a display list in advance.

While the invention has been described in its preferred embodiments, it is to be understood that an arbitrary combination of two or more of the above-mentioned embodiments can be made, various changes can be made in an arbitrary component in accordance with any one of the above-mentioned embodiments, and an arbitrary component in accordance with any one of the above-mentioned embodiments can be omitted within the scope of the invention.

### INDUSTRIAL APPLICABILITY

As mentioned above, the drawing control device in accordance with the present invention has a structure of receiving register setting information including the coordinates and the drawing colors of a graphic to be drawn, and carrying out a drawing process of drawing the graphic on the basis of this register setting information, and is suitable for use in a control panel for consumer and industrial products, etc.

### EXPLANATIONS OF REFERENCE NUMERALS

1 and 1a drawing control device, 2 CPU, 3 CPU bus, 4 frame buffer, 10 and 10a drawing control unit, 11 comparator, 12 command buffer, 20 register bus, 21 second register bus, 30 dedicated drawing unit, 31 drawing unit (A), 32 drawing unit (B), 31a, 32a, 40a, and 50a register, 40 common drawing unit, 50 display list control unit.

1. A drawing control device comprising:
a drawing unit that has a register for drawing and carries out a drawing process of drawing a graphic on a basis of data in said register for drawing; and
a drawing controller that determines whether or not said drawing unit is in a busy state when receiving register setting information about the graphic on which said drawing process is carried out, that compares the data in said register for drawing with said register setting information when said drawing unit is in the busy state and stores said register setting information in a command buffer only when an update is needed, and that updates said register for drawing on a basis of the register setting information stored in said command buffer when the busy state is released and an update is needed.

2. The drawing control device according to claim 1, wherein the drawing controller controls reading of the register setting information stored in the command buffer and a register update independently from an access from a CPU that sends out said register setting information.

3. The drawing control device according to claim 1, wherein the drawing controller includes a dedicated drawing unit that is divided into portions respectively associated with drawing functions, and a common drawing unit that mediates between pixel data input thereto from said dedicated drawing unit, and that carries out a predetermined pixel computation and writes pixel data in a frame buffer.

4. A drawing control device comprising:
a drawing unit that has a register for drawing and carries out a drawing process of drawing a graphic on a basis of data in said register for drawing; and
a drawing controller that determines whether or not said drawing unit is in a busy state when receiving register setting information about the graphic on which said drawing process is carried out, that compares the data in said register for drawing with said register setting information when said drawing unit is in the busy state and stores said register setting information in a display list form in a command buffer only when an update is needed, and that updates said register for drawing on a basis of the register setting information stored in said command buffer in said display list form when the busy state is released and an update is needed.

5. The drawing control device according to claim 4, wherein the register setting information in the display list form is stored in an external memory, and said drawing control device includes a display list controller that decodes said stored display list and transfers this display list decoded thereby to the drawing controller.

6. A drawing control program that implements a drawing control device on a computer, wherein said drawing control program causes the computer to function as:
a drawing unit that has a register for drawing and carries out a drawing process of drawing a graphic on a basis of data in said register for drawing; and
a drawing controller that determines whether or not said drawing unit is in a busy state when receiving register setting information about the graphic on which said drawing process is carried out, that compares the data in said register for drawing with said register setting information when said drawing unit is in the busy state and stores said register setting information in a command buffer only when an update is needed, and that updates said register for drawing on a basis of the register setting information stored in said command buffer when the busy state is released and an update is needed.
